(19) United States
(12) Patent Application Publication
(10) Pub. No.: US 2011/0268023 A1
(43) Pub. Date: Nov. 3, 2011

(54) Mobile device accessory with interworking circuit switched and internet protocol based voice channels

(76) Inventors: Sudharshan Srinivasan, Fremont, CA (US); Kothandraman Ramchandran, Fremont, CA (US); Jai Kumar, Cupertino, CA (US)

(21) Appl. No.: 12/799,661

(22) Filed: Apr. 28, 2010

(51) Int. Cl. H04W 40/00; H04L 12/66

(52) U.S. Cl. 370/328; 370/352

(57) ABSTRACT

An accessory device (31) to a mobile device (34) is described that enables a mobile device to have voice over internet protocol based voice calling functionality that can optionally fall back to circuit switched voice functionality.

This is achieved by providing an accessory device (31) that couples a voice over internet protocol voice channel (32) with a circuit switched voice channel (33) such that a user is able to switch from one channel to another with or without user intervention.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to accessories for mobile devices and specifically to an accessory that has dual interfaces for voice, one based on circuit switched channel and the other based on voice over internet protocol.

2. Prior Art U.S. Patent

Mobile devices span a wide range of devices including cellular phones, portable digital assistants, and portable music players. Cellular phones also exist in various configurations such as feature phones, mid range phones and smartphones.

Mobile device accessories enhance features of existing mobile devices by providing additional features externally as a separate device that is coupled to the mobile device.

There are several accessory functionalities provided in prior art, such as an external camera, global positioning system, or an additional phone line.

The present invention is concerned with providing an accessory that enables voice over internet protocol (VOIP) service that is coupled to a circuit switched voice service in an accessory.

Prior art systems propose accessories that enable adding an additional phone line to an existing mobile device. Such a phone line could be a VOIP line or a circuit switched line. Such devices inter work using local area wireless network technology. But these devices do not offer a method to easily transfer a call from a primary line to secondary line or vice versa. The user would have to manually initiate such a transfer.

For example a user has a mid range mobile phone and wants to add a VOIP line to this phone. This is possible by adding an accessory that provides the VOIP service. But when using the VOIP line if the user encounters bad quality, there is no way for the VOIP accessory device to communicate back to the main mobile device to start initiating a circuit switched call as the local wireless area network connection may not be kept alive.

If the local area wireless network were kept alive during the call then batteries in both the mobile device and the accessory would be drained at a much faster rate.

Another solution to this problem could be to provide a single phone that has dual interfaces one for VOIP and another for circuit channel. But such solutions make the phones very expensive as the phone hardware will have to be programmable so that any of the VOIP codecs in use may be supported. Thus such a solution is only possible using smartphones which are much more expensive than feature phones or midrange phones.

Hence it can be seen that there are no solutions that are cheap and usable in feature phone and mid range phone market, that can provide both VOIP and circuit switched voice channels that inter work together. Similar problems exist with advanced personal digital music players as well. In such cases, providing an accessory with just one additional line that supports either VOIP or circuit switched voice is not sufficient.

The need for an accessory device that has both VOIP and circuit switched channels that inter work with each other exists, as a user may use cheaper VOIP channels when available and switch over to expensive circuit channels only when VOIP channel is either unavailable or unusable. This enables a user to dramatically reduce the use of circuit switched channels and hence cost of communication. Having an accessory device that has VOIP and circuit switched channels inter working with each other, enables a user to be notified of poor quality of VOIP channels and prompt a user to change over to a circuit channel with minimal delays in switch over.

Such an accessory device is not known to exists in prior art.

Following paragraphs in current section describe relevant prior arts in this field.

Prior art US Doc 20080200208 proposes a mobile device accessory to provide an extra line to the mobile device using a short range communication. But this does not address the need for providing VOIP and circuit switched channels that that inter work with each other, to enable a user to easily switch from one voice channel to the other when necessary.

Also, it is to be noted that by just combining an additional line in the accessory device proposed by this prior art will not provide features of a system where VOIP channels inter works with circuit switched channel.

Prior art U.S. Pat. No. 5,606,594 proposes a personal digital assistant (PDA) accessory that can interoperate with a PDA. This provides a PDA with a capability to add a cellular phone line. But this does not address the need for providing VOIP and circuit switched channels that that inter work with each other, to enable a user to easily switch from one voice channel to the other when necessary.

As can be seen from above, all known prior arts suffer from some limitations in offering a solution to address the need for an accessory device that can provide VOIP and circuit switched channels that inter work with each other.

3. Objects and Advantages

Accordingly, several objects and advantages of the present invention are:
a) to provide a mobile device accessory that has both circuit switched and VOIP channels that inter work with each other to enable a user to switch between the two channels when necessary; and
b) to provide a mobile device system using an accessory device that interoperates with the mobile device that enables reduction of circuit switched voice usage by enabling VOIP usage as the main alternative.

### SUMMARY

In accordance with present invention a mobile device accessory is described that has dual interfaces for providing voice communication, where one interface provides voice communication using a VOIP channel that inter works with the other interface that provides voice communication using a circuit switched channel.

Combining two voice interfaces in an accessory device enables tracking quality issues of voice channels and efficiently switch over from one channel to another whenever necessary. This accessory device provides a much more power efficient system as compared with systems of prior art that propose two independent devices for corresponding voice channels where tracking quality issues of one channel and communicating this information to another channel is not power efficient.

By providing dual interfaces for voice channels in an accessory, most PDAs, mid range phones and feature phones can be enabled with VOIP functionality that can fall back to circuit switched functionality when needed in the most power efficient manner.

As mobile broadband data plans are getting cheaper and bandwidth allowed is increasing, using data channels is the most efficient option to transfer voice. But depending on VOIP channels for all mobile conversations may not be the most reliable option, as VOIP services degrade in quality if the cellular network is congested with too many users. Such a condition will occur more often in densely populated areas. Hence having a quick and efficient fallback option to use circuit switched calls when VOIP channel quality is degraded, is the best option.

Such an option is provided by the accessory device of present invention, that combines a VOIP channel with circuit channel so that a user is given advanced warning of degrading VOIP channel quality, using which a user can opt to switch over to a circuit channel or cancel the call and retry at a later point in time.

During the use of circuit switched call, the VOIP channel is monitored and if the situation improves, then a user may be prompted again to move back to the VOIP channel.

Such a feature could be provided by a dual modem phone, but that will require users to buy new equipment and dual modem phones are quite expensive.

Hence an accessory device with dual interfaces one for VOIP and other for a circuit switched channel that inter work with each other is the cheapest option that has the best mass market appeal.

A user who has a portable media player may use this accessory to add VOIP functionality and a user with a feature phone or a mid range phone may also add this accessory to get VOIP functionality with a fallback to circuit switched call.

Hence it can be seen that by combining a VOIP channel and circuit switched channel in an accessory that inter work with each other, provides an unobvious result of enabling any mobile device with a VOIP solution with a fallback to circuit switched channel that is most power efficient and cost efficient when compared to any solution of prior art.

### DRAWINGS

### Figures

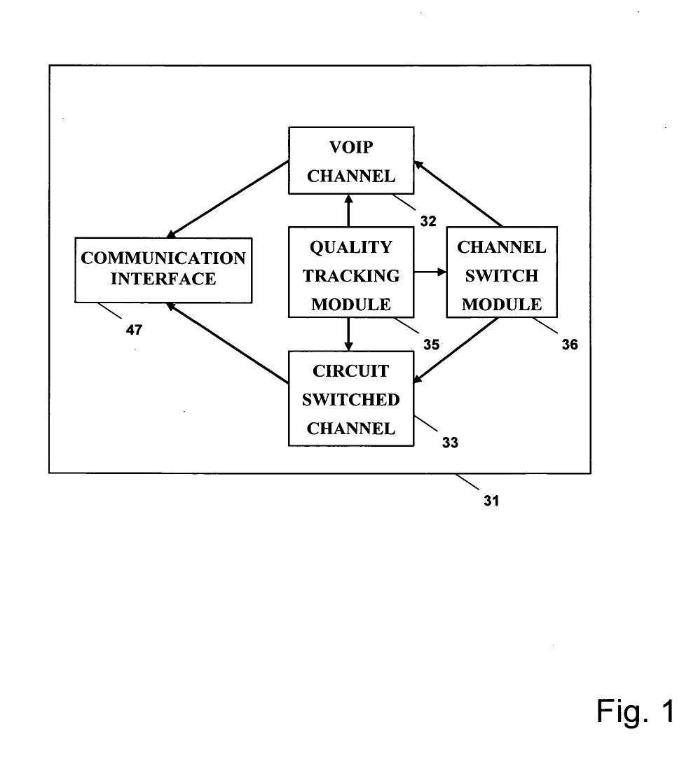

FIG. 1 shows an accessory device with coupled VOIP and circuit switched voice interfaces.

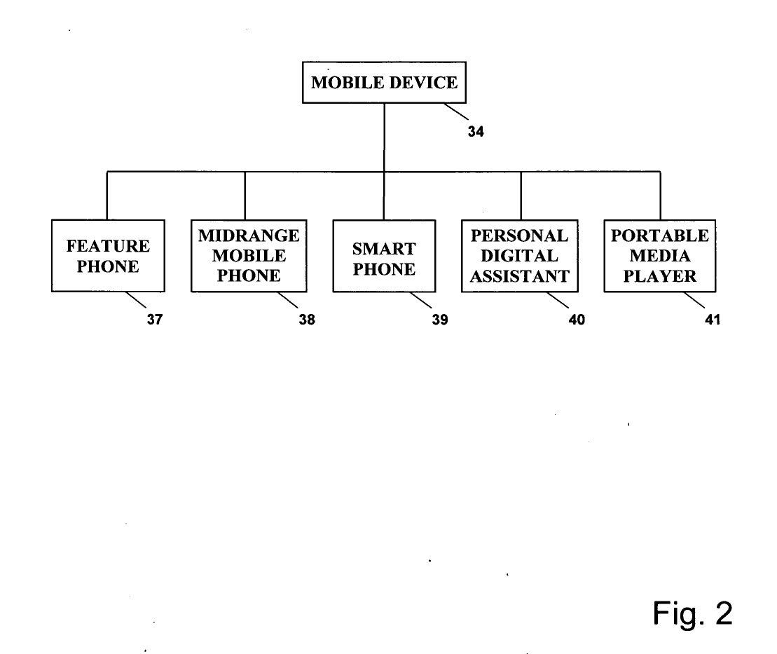

FIG. 2 shows embodiments of the mobile device.

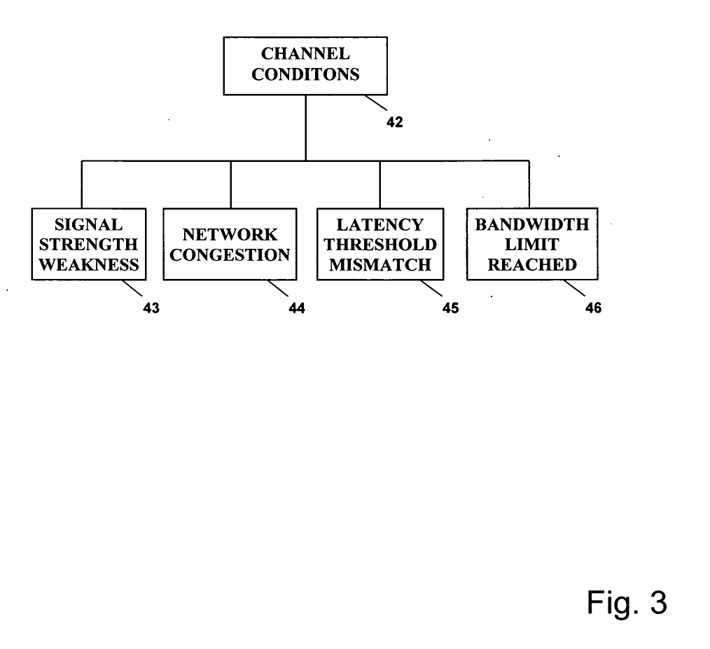

FIG. 3 shows embodiments of channel conditions.

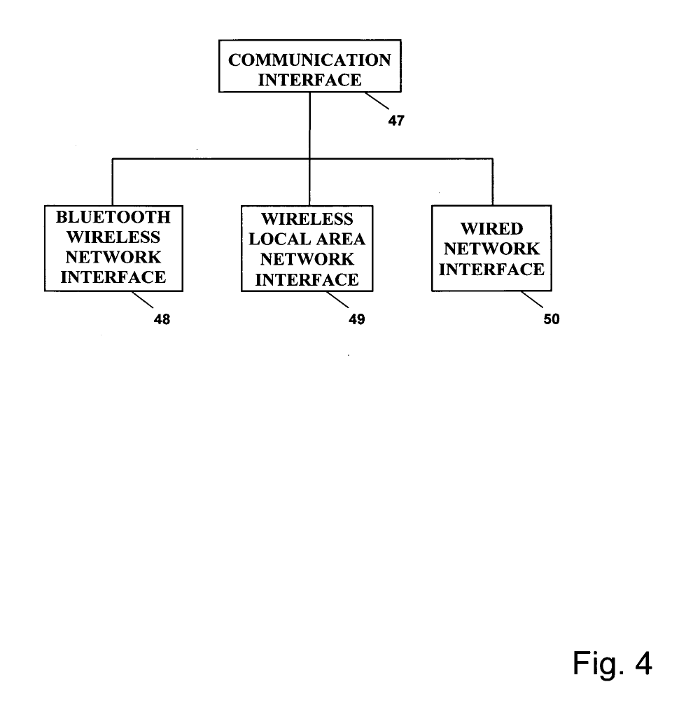

FIG. 4 shows embodiments of communication interface.

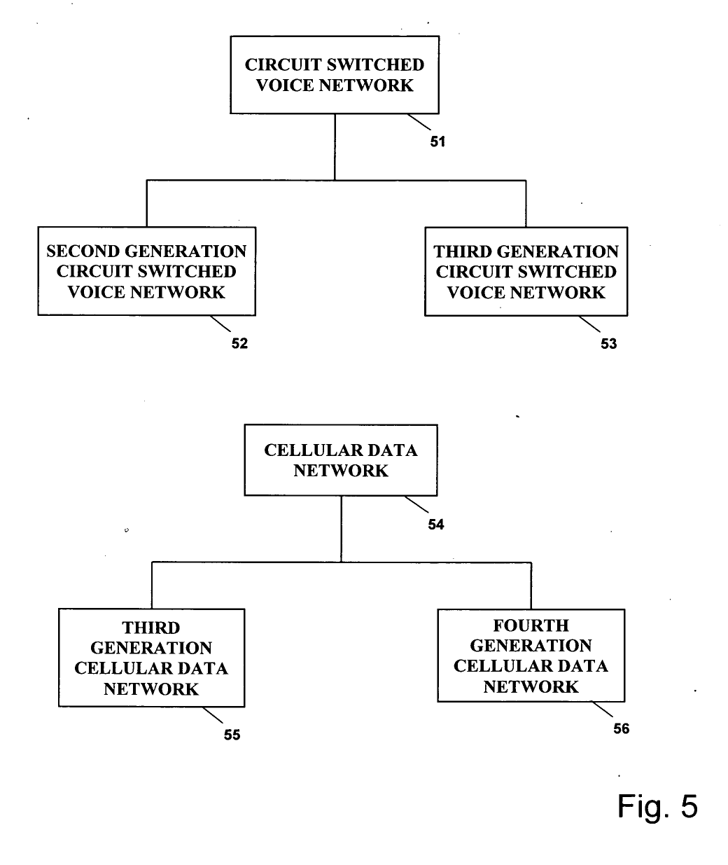

FIG. 5 shows embodiments of circuit switched voice networks and embodiments of cellular data networks.

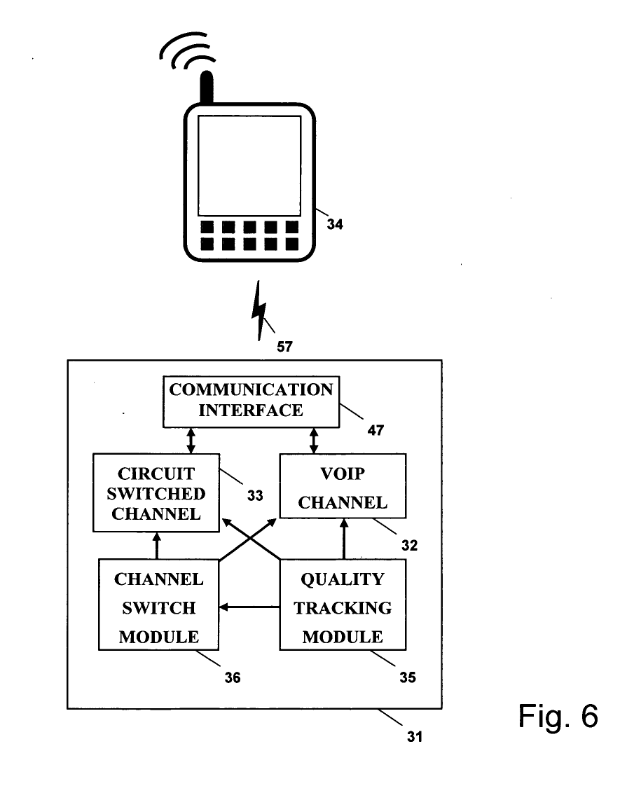

FIG. 6 shows details of a system consisting of a mobile device coupled with an accessory device communicating through the communication interface.

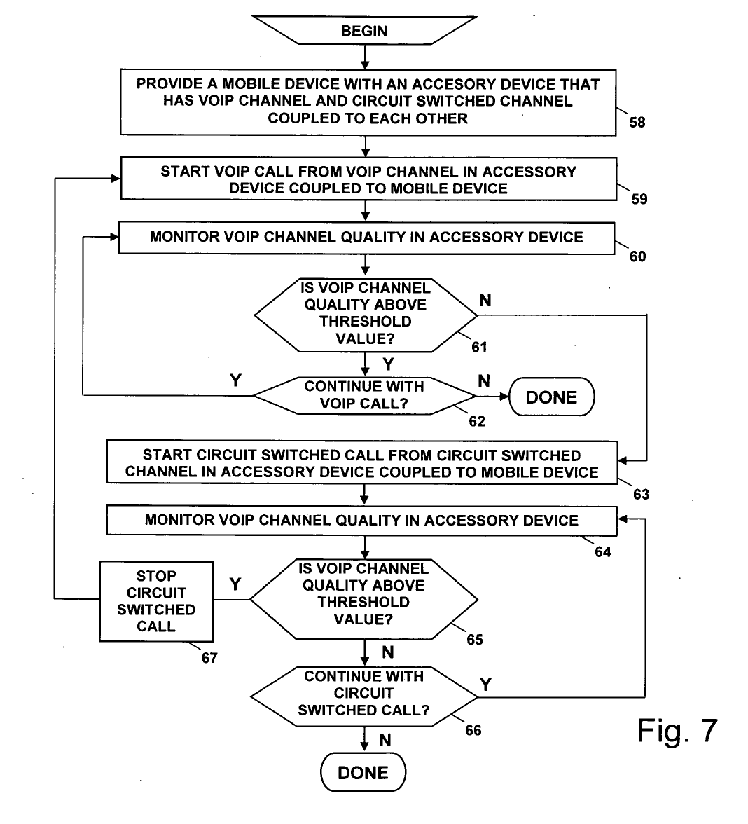

FIG. 7 shows a flow chart of a method to enable a mobile device with VOIP call that is coupled to circuit switched voice as a fallback option.

### REFERENCE NUMERALS

31 accessory device
32 VOIP channel
33 circuit switched channel
34 mobile device
35 quality tracking module
36 channel switch module
37 feature mobile phone
38 midrange mobile phone
39 smart phone
40 personal digital assistant
41 portable media player
42 channel conditions
43 signal strength weakness condition
44 network congestion condition
45 latency threshold mismatch condition
46 bandwidth limit reached condition
47 communication interface
48 blue tooth wireless network interface
49 wireless local area network interface
50 wired network interface
51 circuit switched voice networks
52 second generation circuit switched voice network
53 third generation circuit switched voice network
54 cellular data network
55 of third generation cellular data network
56 fourth generation cellular data network
57 local area wireless signals
58 step
59 step
60 step
61 step
62 step
63 step
64 step
65 step
66 step
67 step

### DETAILED DESCRIPTION OF PREFERRED EMBODIMENT

In the following description, first an accessory device with coupled VOIP and circuit switch channels is described. The coupling enables tracking voice channel conditions and switch over from one channel to the other with optional user intervention. This tight coupling of VOIP and circuit switch channels in accessory device of present invention is mandatory to provide the best power efficient dual interface solution. Then details of a system consisting of a mobile device coupled to accessory device are described.

FIG. 1 shows an accessory device 31 with dual interfaces for providing voice communication. One interface provides voice communication using a VOIP channel 32 that inter works with the other interface that provides voice communication using a circuit switched channel 33. The accessory device 31 is used as accessory to a mobile device 34.

Since two voice channels are provided in an accessory device 31, most PDAs, mid range phones and feature phones can be enabled with VOIP call functionality with the ability to fall back to circuit switched voice calls whenever VOIP channel quality is degraded. While in a VOIP call, a user of accessory device 31 is optionally given advanced warning of degrading VOIP channel 32 quality. At that point of time, the user has an option to switch over to circuit switched channel 33 or cancel the call and retry the call later. Alternately, the switchover option to circuit switched channel 33 can be preset in a user profile that automatically triggers the switchover from VOIP channel 32 when call quality deteriorates or other quality threshold conditions are triggered.

Quality of VOIP call in VOIP channel 32 is monitored by quality tracking module 35 that tracks quality of VOIP calls at periodic intervals. When quality tracking module 35 determines that VOIP call quality has degraded below a threshold level, it notifies the user by providing a visual or sound alert. Through a menu option, the user can manually switch to circuit switched channel 33 and continue the call without any disruptions. The visual and audio alert indication can be provided to the user either in the mobile device 34 or in the accessory device 31.

Switching over a call from VOIP channel 32 to circuit switched channel 33 is facilitated by channel switch module 36 that is coupled with quality tracking module 35. Once quality tracking module 35 provides notification to channel switch module 36 to make the switch, channel switch module 36 moves ongoing call from VOIP channel 32 to circuit switched channel 33.

Even after the switch to circuit switched channel 33 is made, quality tracking module 35 still continues monitoring quality of both channels and if quality of VOIP channel 32 improves back to threshold levels, notification is again sent to channel switch module 36 to optionally switch back the call to VOIP channel 32 from circuit switched channel 33.

FIG. 2 shows that mobile device 34 can be one of feature mobile phone 37, midrange mobile phone 38, smart phone 39, personal digital assistant 40, and portable media player 41.

FIG. 3 shows that channel conditions 42 that are monitored for voice channels can be one of signal strength weakness condition 43, network congestion condition 44, latency threshold mismatch condition 45, and bandwidth limit reached condition 46. Signal strength weakness condition 43 could occur when accessory device 31 is out of wireless range. Too many simultaneous users on the data network could lead to triggering of network congestion condition 44. For the VOIP channel, if data packets are not arriving within certain pre specified time limits, then this will trigger latency threshold mismatch condition 45. When the data limit of bandwidth that a user subscribes to is reached, the bandwidth limit reached condition 46 is triggered.

FIG. 4 shows that communication interface 47 in accessory device 31 is used to communicate with mobile device 34. Communication interface 47 can be one of blue tooth wireless network interface 48, wireless local area network interface 49, and wired network interface 50.

FIG. 5 shows that circuit switched channel 33 is provided by circuit switched voice networks 51 that can be one of second generation circuit switched voice network 52, and third generation circuit switched voice network 53. VOIP channel 32 is provided by cellular data network 54 that can be one of of third generation cellular data network 55, and fourth generation cellular data network 56.

FIG. 6 shows details of a system consisting of mobile device 34 coupled with an accessory device 31 that consists of VOIP channel 32 and circuit switched channel 33 for voice communication. Accessory device 31 communicates with mobile device 34 through the communication interface 47 using local area wireless signals 57. Quality of VOIP call in VOIP channel 32 is monitored by quality tracking module 35 and when it determines that VOIP call quality had degraded below a threshold level, call is transferred to circuit switched channel 33 if the system is set for automatic switchover. If automatic switchover is not selected in user profile, then user can manually switch to circuit switched channel 33.

FIG. 7 shows a flow chart of a method to enable a mobile device with VOIP call that is coupled to circuit switched voice as a fallback option.

In step 58, a mobile device 34 is provided with an accessory device 31 that has VOIP channel 32 and circuit switched channel 33 coupled to each other.

In step 59, VOIP call is started using VOIP channel 32 of accessory device 31.

In step 60, quality of VOIP channel 32 of accessory device 31 is monitored using quality tracking module 35.

In step 61, a check is made by quality tracking module 35 to determine if VOIP call quality has degraded below a threshold level.

In step 62, since VOIP call quality is above a threshold value, a check is made to determine if user wants to continue with the VOIP call or not. If the VOIP call is to be continued, then quality of VOIP channel 32 is again monitored using quality tracking module 35 in step 60. Otherwise the VOIP call is terminated.

In step 63, since VOIP call quality has degraded below a threshold level, channel switch module 36 moves ongoing call from VOIP channel 32 to circuit switched channel 33.

In step 64, quality of VOIP channel 32 of accessory device 31 is again monitored using quality tracking module 35.

In step 65, a check is made by quality tracking module 35 to determine if quality of VOIP channel 32 has degraded below a threshold level. If the quality is below a threshold level, then step 66 is executed and if the quality is above a threshold level, then step 67 is executed.

In step 66, a check is made to determine if user wants to continue with the circuit switched call or not. If the circuit switched call is to be continued, then quality of VOIP channel 32 is again monitored using quality tracking module 35 in step 64. Otherwise the circuit switched call is terminated.

In step 67, circuit switched call is stopped since the check made by quality tracking module 35 determined that quality of VOIP channel 32 has improved above a threshold level. After stopping the circuit switched call, VOIP call is started using VOIP channel 32 in step 59.

### ADVANTAGES

From the description above a number of advantages of present invention become evident:
a) a mobile device accessory is provided that has both circuit switched and VOIP channels that inter work with each other to enable a user to switch between the two channels when necessary; and
b) a mobile device system using an accessory device is provided that interoperates with the mobile device that enables reduction of circuit switched voice usage by enabling VOIP usage as the main alternative.

### CONCLUSION, RAMIFICATIONS AND SCOPE

Accordingly, the reader will see that by combining a VOIP channel with a circuit switched channel that inter work with each other in an mobile device accessory provides the most power efficient and cost efficient solution to enable existing mobile device users to make full use of data channels to transfer voice bits and fall back to circuit channels only when the need arises.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. An accessory device to a mobile device comprising:
voice over internet protocol voice channel;
circuit switched voice channel;
channel condition tracking function to track channel conditions of either of said voice channels;
channel switch function that enables a user to monitor channel conditions and switch from one said channel to another said channel with optional user intervention, and enables said user to setup profiles that enable automatic switch over from one said channel to another said channel; and communication interface to communicate with said mobile device.

2. The accessory device of claim 1, wherein said mobile device is selected from group consisting of feature phone, midrange phone, smartphone, personal digital assistant, and portable music player.

3. The accessory device of claim 1, wherein said channel condition is selected from group consisting of signal strength weakness condition, network congestion condition, latency threshold mismatch condition, and bandwidth limit reached condition.

4. The accessory device of claim 1, wherein said interface to said mobile device is selected from group consisting of blue tooth wireless network interface, wireless local area network interface, and wired network interface.

5. The accessory device of claim 1, wherein said circuit switched voice channel is provided by circuit switched voice networks selected from group consisting of second generation circuit switched voice network, and third generation circuit switched voice network, and said voice over internet protocol voice channel is provided by cellular data networks selected from group consisting of third generation cellular data networks, and fourth generation cellular data networks.

6. A system to enable voice over internet protocol service in a mobile device comprising:
said mobile device;
a accessory device to said mobile device comprising voice over internet protocol voice channel, circuit switched voice channel, and a communication interface to said mobile device wherein said voice channels are coupled together to enable switch over from one to another with optional user intervention.

7. The system of claim 6, wherein said mobile device is selected from group consisting of feature phone, midrange phone, smartphone, personal digital assistant, and portable music player.

8. The system of claim 6, wherein said channel condition is selected from group consisting of signal strength weakness condition, network congestion condition, latency threshold mismatch condition, and bandwidth limit reached condition.

9. The system of claim 6, wherein said interface to said mobile device is selected from group consisting of blue tooth wireless network interface, wireless local area network interface, and wired network interface.

10. The system of claim 6, wherein said circuit switched voice channel is provided by circuit switched voice networks selected from group consisting of second generation circuit switched voice network, and third generation circuit switched voice network, and said voice over internet protocol voice channel is provided by cellular data networks selected from group consisting of third generation cellular data networks, and fourth generation cellular data networks.

11. A method of enabling voice over internet protocol service to a mobile device comprising:
providing an accessory device to said mobile device wherein said accessory device comprises voice over internet protocol voice channel, circuit switched voice channel, and a communication interface from said mobile device to said accessory device wherein said voice channels are coupled together to enable switch over from one said channel to another channel with optional user intervention based on channel conditions.

12. The method of claim 11, wherein said mobile device is selected from group consisting of feature phone, midrange phone, smartphone, personal digital assistant, and portable music player.

13. The method of claim 11, wherein said channel condition is selected from group consisting of signal strength weakness condition, network congestion condition, latency threshold mismatch condition, and bandwidth limit reached condition.

14. The method of claim 11, wherein said interface to said mobile device is selected from group consisting of blue tooth wireless network interface, wireless local area network interface, and wired network interface.

15. The method of claim 11, wherein said circuit switched voice channel is provided by circuit switched voice networks selected from group consisting of second generation circuit switched voice network, and third generation circuit switched voice network, and said voice over internet protocol voice channel is provided by cellular data networks selected from group consisting of third generation cellular data networks, and fourth generation cellular data networks.
